(19) United States
(12) Patent Application Publication
(10) Pub. No.: US 2025/0328764 A1
(43) Pub. Date: Oct. 23, 2025

(54) METHOD AND APPARATUS FOR ACCELERATING TRANSFORMER USING PRUNING AND QUANTIZATION

(71) Applicant: POSTECH RESEARCH AND BUSINESS DEVELOPMENT FOUNDATION, Pohang-si (KR)

(72) Inventors: Eun Ji KWON, Pohang-si (KR); Seokhyeong KANG, Pohang-si (KR)

(73) Assignee: POSTECH RESEARCH AND BUSINESS DEVELOPMENT FOUNDATION, Pohang-si (KR)

(21) Appl. No.: 19/057,788

(22) Filed: Feb. 19, 2025

(30) Foreign Application Priority Data
Apr. 17, 2024 (KR) 10-2024-0051528

(51) Int. Cl. G06N 3/082; G06N 3/045; G06N 3/0495

(52) U.S. Cl. CPC G06N 3/082; G06N 3/045; G06N 3/0495

(57) ABSTRACT

Disclosed are a transformer model optimization and head scheduling method and a transformer acceleration method, which may include: receiving dense scheduling data and a zero-line mask generated using the transformer model optimization and head scheduling method; outputting a dense operation result by performing a tiled matrix multiplication on the received dense scheduling data; and outputting a final operation result by transforming the dense operation result into a sparse matrix, using the zero-line mask.

### CROSS-REFERENCE TO RELATED APPLICATIONS

This application claims the benefit under 35 USC § 119(a) of Korean Patent Application No. 10-2024-0051528 filed on Apr. 17, 2024, in the Korean Intellectual Property Office, the entire disclosure of which is incorporated herein by reference for all purposes.

### BACKGROUND

### 1. Field

The following embodiments relate to a method and apparatus for accelerating a transformer using pruning and quantization.

### 2. Description of Related Art

A transformer is widely used in the field of computer vision including, for example, image classification, object detection, and semantic segmentation, in addition to natural language processing (NLP). A transformer accelerator is a hardware device designed to execute a transformer architecture-based deep learning model. The transformer accelerator may facilitate efficient execution of a transformer model used to process NLP, image recognition, and other complex tasks. In particular, the transformer accelerator may accelerate the computation (or operations) of a computation-intensive transformer model to improve real-time performance, enabling high-performance computing (HPC). The transformer accelerator may also improve computational performance while minimizing energy consumption.

### SUMMARY

According to an embodiment, a transformer model optimization and head scheduling method may include: acquiring an importance score for each of lines included in each of heads of a transformer model to prune the heads of the transformer model, by performing a previously learned line selection operation; performing coarse-grained pruning on the heads, based on the importance score and a threshold value; performing fine-grained pruning on heads unpruned through the coarse-grained pruning; and optimizing a placement of the heads based on a workload of the heads on which the coarse-grained pruning and the fine-grained pruning has been performed.

The threshold value may be determined based on the importance score and a ratio of lines to be removed among lines of a predetermined pruning ratio.

The coarse-grained pruning may be to prune lines with the importance score less than the threshold value, based on a predetermined condition.

The fine-grained pruning may be to prune lines with the importance score less than the threshold value among lines unpruned through the coarse-grained pruning.

The transformer model optimization and head scheduling method may further include reorganizing the heads based on the unpruned lines after the coarse-grained pruning.

The transformer model optimization and head scheduling method may further include performing dynamic post-training quantization (PTQ) on heads pruned through the fine-grained pruning.

The performing of the dynamic PTQ may include performing intra-layer dynamic linear quantization on a weight of the transformer model.

The optimizing of the placement of the heads may include: determining a row-wise sparsity and a column-wise sparsity at each of heads included in each of encoder layers of the transformer model; transforming a sparse matrix into a dense matrix by removing zero lines from each of the heads; and optimizing a placement of the heads in each of the layers, based on a workload of each of the heads.

According to an embodiment, an operating method of a transformer accelerator, the operating method may include: receiving data associated with operations of a transformer model, and transforming the received data into dense data; receiving dense scheduling data and a zero-line mask generated based on a transformer model optimization and head scheduling method; outputting a dense operation result by performing a tiled matrix multiplication based on at least one of the dense data, the dense scheduling data, or the zero-line mask; and outputting a final operation result by transforming the dense operation result into a sparse matrix, using the zero-line mask.

The outputting of the dense operation result may include performing a tile-based dynamic fixed-point (DFP) quantization on the dense data or the dense scheduling data.

The performing of the tile-based DFP quantization may include transforming, into an INT8 data type, input data and weight data included in the dense data or the dense scheduling data.

The performing of the tile-based DFP quantization may further include performing dequantization that divides, by a fractional precision, a result of a multiplication operation between the transformed input data and the transformed weight data.

The performing of the tile-based DFP quantization may further include obtaining an operation result of an INT8 type by performing quantization on the dequantization result and storing the fractional precision separately.

According to an embodiment, an electronic device may include: a memory storing instructions; and at least one processor. The instructions may, when executed by the at least one processor, cause the electronic device to: acquire an importance score for each of lines included in each of heads of a transformer model to prune the heads of the transformer model, by performing a previously learned line selection operation; perform coarse-grained pruning on the heads, based on the importance score and a threshold value; perform fine-grained pruning on heads unpruned through the coarse-grained pruning; and optimize a placement of the heads, based on a workload of the heads on which the coarse-grained pruning and the fine-grained pruning has been performed.

According to an embodiment, a transformer accelerator may include: a memory storing the instructions; and at least one processor. The instructions may, when executed by the at least one processor, cause the transformer accelerator to: receive data associated with operations of a transformer model, and transform the data into dense data; receive dense scheduling data and a zero-line mask generated based on a transformer model optimization and head scheduling method; output a dense operation result by performing a tiled matrix multiplication based on at least one of the dense data, the dense scheduling data, or the zero-line mask; and output a final operation result by transforming the dense operation result into a sparse matrix, using the zero-line mask.

According to an embodiment, an electronic device may include: a memory storing instructions; a transformer accelerator; and at least one processor. The instructions may, when executed by the at least one processor, cause the electronic device to: perform an optimization and head scheduling operation on a transformer model; and perform an acceleration operation to accelerate, by the transformer accelerator, an operation of the transformer model on which head scheduling has been performed. The optimization and head scheduling operation may include: acquiring an importance score for each of lines included in each of heads of the transformer model to prune the heads of the transformer model, by performing a previously learned line selection operation; performing coarse-grained pruning on the heads based on the importance score and a threshold value; performing fine-grained pruning on heads unpruned through the coarse-grained pruning; and optimizing a placement of the heads based on a workload of the coarse-grained pruning and the fine-grained pruning has been performed. The acceleration operation may include: receiving data associated with operations of the transformer model, and transforming the data into dense data; receiving dense scheduling data and a zero-line mask generated based on the optimization and head scheduling operation; outputting a dense operation result by performing a tiled matrix multiplication based on at least one of the dense data, the dense scheduling data, or the zero-line mask; and outputting a final operation result by transforming the dense operation result into a sparse matrix, using the zero-line mask.

### BRIEF DESCRIPTION OF THE DRAWINGS

These and/or other aspects, features, and advantages of the present disclosure will become apparent and more readily appreciated from the following description of embodiments, taken in conjunction with the accompanying drawings of which:

FIG. 1 is a schematic diagram illustrating a transformer encoder according to an embodiment;

FIG. 2 is a diagram illustrating various types of sparsity of a transformer model according to an embodiment;

FIG. 3 is a schematic diagram illustrating a transformer model optimization operation of an electronic device according to an embodiment;

FIGS. 4 and 5 are schematic diagrams illustrating a head scheduling operation of an electronic device according to an embodiment;

FIG. 6 is a schematic diagram illustrating an operation of a transformer accelerator according to an embodiment;

FIG. 7 is a schematic diagram illustrating a sparse quantized general matrix-to-matrix multiplication (SQ-GEMM) according to an embodiment;

FIG. 8 is a diagram illustrating tile-based dynamic fixed-point (DFP) quantization in an SQ-GEMM operation according to an embodiment;

FIG. 9 is a diagram illustrating a transformer accelerator including an SQ-GEMM module according to an embodiment;

FIG. 10 is a flowchart illustrating a flow of operations of an electronic device according to an embodiment;

FIG. 11 is a flowchart illustrating a flow of operations of a transformer accelerator according to an embodiment; and

FIG. 12 is a block diagram illustrating an electronic device according to an embodiment.

### DETAILED DESCRIPTION

The following structural or functional descriptions of embodiments are merely intended for the purpose of describing the embodiments, and the embodiments may be implemented in various forms. The embodiments are not meant to be limited, but it is intended that various modifications, equivalents, and alternatives are also covered within the scope of the claims.

Although the terms “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure.

It will be understood that when a component is referred to as being “connected to” another component, the component can be directly connected or coupled to the other component, or intervening components may be present.

As used herein, the singular forms “a,” “an,” and “the” are intended to include the plural forms as well, unless the context clearly indicates otherwise. As used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof.

As used herein, “A or B,” “at least one of A and B,” “at least one of A or B,” “A, B or C,” “at least one of A, B and C,” and “A, B, or C,” each of which may include any one of the items listed together in the corresponding one of the phrases, or all possible combinations thereof.

Unless otherwise defined, all terms used herein including technical or scientific terms have the same meanings as those generally understood consistent with and after an understanding of the present disclosure. Terms, such as those defined in commonly used dictionaries, should be construed to have meanings matching with contextual meanings in the relevant art and the present disclosure, and are not to be construed as an ideal or excessively formal meaning unless otherwise defined herein.

Hereinafter, the embodiments will be described in detail with reference to the accompanying drawings. When describing the embodiments with reference to the accompanying drawings, like reference numerals refer to like components and a repeated description related thereto will be omitted.

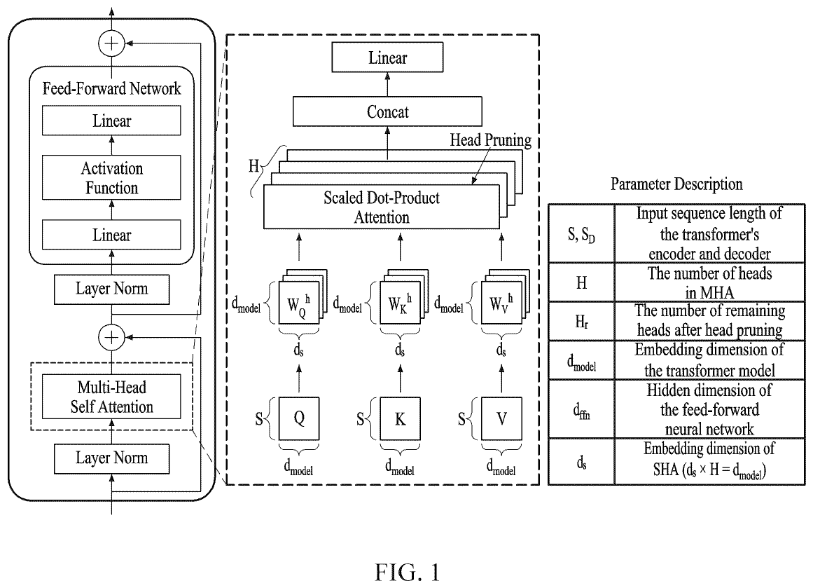

FIG. 1 is a schematic diagram illustrating a transformer encoder according to an embodiment.

A transformer encoder may include multiple encoder layers stacked in series. An encoder layer may consist of multi-head self-attention (MSA) and feed-forward neural network (FFN). A decoder may include multiple decoder layers each including MSA, multi-head cross-attention (MCA), and FFN. Multi-head attention (MHA) including MSA and MCA may be a concatenation of single-head attention (SHA).

In SHA, a query vector Qi, a key vector Ki, and a value vector Vᵢ may be generated by multiplying an input query Q, a key K, and a value V by learnable weights WiQ, WiK, and WiV, respectively. After embedding, scaled dot-product (SDP) attention may be performed to determine the relevance of a specific feature to other features.

A decoder layer may receive, as an initial input, multiple object queries and use encoded information. In a vision transformer (ViT), an image may be cut into patches and used as an input to the transformer encoder, which may be analogous to creating an image in the form of a word sequence.

In various embodiments described below, an electronic device may perform a transformer model optimization operation and a sparse quantized general matrix-to-matrix multiplication (SQ-GEMM) operation. The transformer model optimization operation may be broadly divided into i) coarse-grained pruning, ii) fine-grained pruning, and iii) intra-layer or tile-based dynamic post-training quantization (PTQ). In this case, head scheduling may be performed to skip unnecessary head operations, and a load imbalance of SHA processing engines operating in parallel may be solved. The head scheduling may be performed by predicting, in advance, the workload of transformer models with different degrees of sparsity in different regions and different sizes.

SQ-GEMM may be a transformer accelerator that may skip head-wise and line-wise operations. The transformer accelerator may perform the SQ-GEMM operation that uses various line-wise sparsity of inputs and weights. The transformer accelerator may support dynamic tile-based quantization and may better maintain the accuracy of a highly pruned transformer model. Quantization and dequantization may be simplified by shared scheduling elements in tile-wise data groups.

Hereinafter, the head scheduling method and SQ-GEMM are described in more detail.

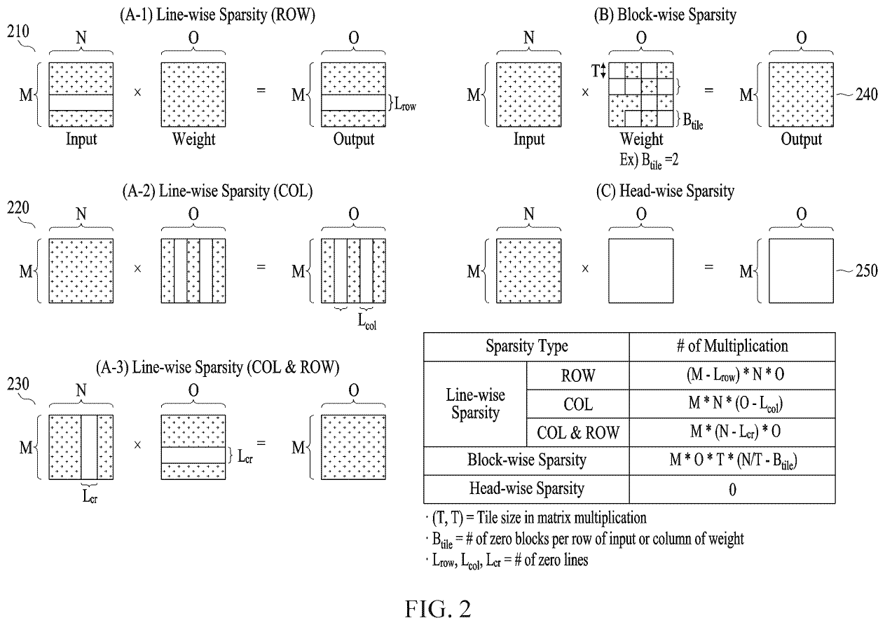

FIG. 2 is a diagram illustrating various types of sparsity of a transformer model according to an embodiment.

Referring to FIG. 2, a transformer model may have various types of sparsity. As representative examples of sparsity, line-wise sparsity, block-wise sparsity, and head-wise sparsity may be defined. In the transformer model, patch or token pruning may cause row-wise sparsity 210 of an input. Also, SHA column or dimension pruning may cause column-wise sparsity 220 of weights. Also, dimension pruning of the transformer model may cause column-wise sparsity of the input and row-wise sparsity of the weights, which may cause matrix-wise sparsity 230. Also, block pruning may cause block-wise sparsity 240. Additionally, a zero (0) input generated by a softmax or rectified linear unit (ReLU) activation function in a transformer operation (or computation) may form block-wise sparsity. Also, head pruning may cause head-wise sparsity 250, i.e., all weights included in one head in MSA may be zero (0).

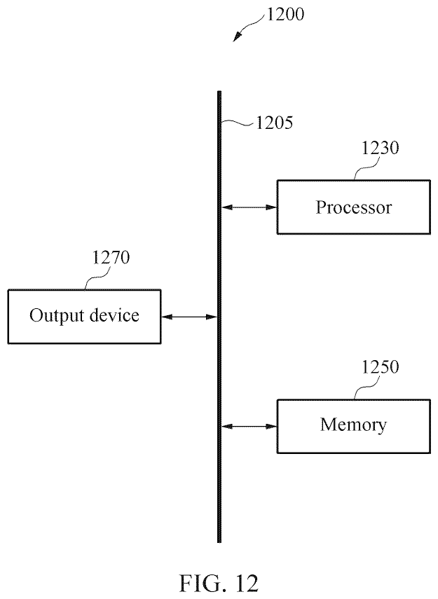

An electronic device (e.g., an electronic device 1200 of FIG. 12), according to one embodiment, may perform, in the transformer operation, a transformer model optimization operation that optimizes the weights (or parameters) of the transformer model and a head scheduling operation that schedules heads of the transformer model. The electronic device 1200 may then perform an SQ-GEMM operation based on the optimized weights, the scheduled heads, and a received input.

In one embodiment, the electronic device 1200 may reduce, using sparsity, the number of operations for a matrix multiplication (e.g., input [M×N] and weight [N×O]). In the absence of sparsity, the number of multiplication operations in the matrix multiplication may be M·N·O. For the three types of line-wise sparsity, performing the matrix multiplication with sparsity considered may skip the number of multiplication operations of [L_{row} (sparse rows) ·N·O], [L_{col} (sparse columns) ·M·N], and [L_{cr} (sparse matrix) ·M·O], respectively. In addition, an operation with block-wise sparsity considered may skip the number of multiplication operations of [M·O·T·Bₜᵢₗₑ], where T may denote a matrix partition size, and Bₜᵢₗₑ may denote the number of zero (0) blocks in operations required for a matrix in one output tile. Also, an operation with head-wise sparsity considered may skip as many head-wise matrix multiplications as the number of sparse heads.

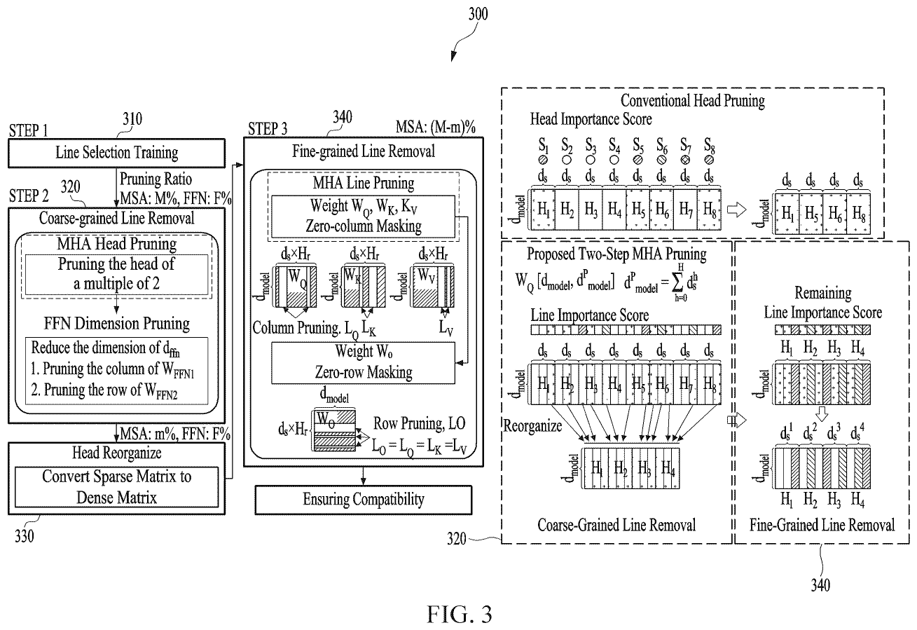

FIG. 3 is a schematic diagram illustrating a transformer model optimization operation of an electronic device according to an embodiment.

The description provided above with reference to FIGS. 1 and 2 may be equally applicable to FIG. 3, and may thus not be repeated.

One or more blocks and combinations of blocks shown in FIG. 3 may be implemented by a special-purpose hardware-based computer that performs a specific function, or by a combination of special-purpose hardware and computer instructions.

For ease of description, operations 310 through 340 are described as being performed using the electronic device 1200 shown in FIG. 12. However, operations 310 through 340 may be used with any other suitable electronic device and within any suitable system.

Further, although the operations described with reference to FIG. 3 may be performed in the order and manner as shown, the order of some of the operations may be changed or some of the operations may be omitted without departing from the spirit and scope of the embodiments shown and described. The operations described with reference to FIG. 3 may be performed in parallel or simultaneously.

In one embodiment, the electronic device 1200 may perform a transformer model optimization operation 300 through a line selection operation, a coarse-grained pruning operation, and a fine-grained pruning operation.

At operation 310, the electronic device 1200 may store importance scores through training (or learning) that performs the line selection operation for pruning MHA heads. The importance scores (Q, K, V, O, etc.), which represent the importance of each line within a network of the electronic device 1200, may be learned end-to-end in a transformer model. The electronic device 1200 may apply L1 normalization to line-wise importance scores to guide the transformer model to assign a low value to an unimportant line, thereby allowing the electronic device 1200 to readily identify lines that may be pruned out. The number of importance scores in each weight matrix may be equal to the number of columns (W_{Q}, W_{K}, W_{V}, W_{F1}) or rows (W_{O}, W_{F2}) in that matrix. The electronic device 1200 may use the importance scores to determine which lines are to be pruned more finely.

The electronic device 1200 may perform the previously learned line selection operation to acquire an importance score for each of lines included in each of heads to prune the heads. The electronic device 1200 may determine a threshold value to determine which lines to remove from the model by the line selection operation. The threshold value may be determined based on the importance scores and a ratio of the lines to be removed among lines of a predetermined pruning ratio. A process of determining the threshold value may include ranking the normalized importance scores calculated during training (or learning). Based on the predetermined pruning ratio (e.g., M %), a head scheduler may acquire the threshold value, ϵ. For example, in a case where 30% of the lines are to be pruned in MHA, an importance score corresponding to the top 70% may be determined as the threshold value ϵ. The threshold value ϵ may be used as a reference value for determining which lines to keep and which to remove. In this case, lines with an importance score being less than or equal to ϵ may be considered unimportant and marked as a removal target that needs to be removed.

At operation 320, the electronic device 1200 may perform the coarse-grained pruning (or coarse-grained line removal) on the heads based on the importance scores and the threshold value. The coarse-grained pruning may prune lines having an importance score less than the threshold value based on a predetermined condition. The electronic device 1200 may use the line-wise importance scores to perform the coarse-grained pruning.

The predetermined condition may be a condition that requires the head scheduler to divide the number of lines of weights (e.g., d^{WQ}_{model}, d^{WK}_{model}, d^{WV}_{model}, and d^{WO}_{model}) by a single-head dimension (e.g., dₛ) after line pruning in the coarse-grained pruning. The single-head dimension may refer to the number of lines a single head has. In addition, it may be necessary to ensure that the number of heads Hᵣ remaining in each layer after the coarse-grained pruning is proportional to the number of SHA PEs that exist after the coarse-grained pruning. Thus, in the coarse-grained pruning, MHA pruning may not be performed by a predetermined MHA pruning ratio (e.g., M % specified by the line selection operation). Therefore, the coarse-grained pruning may be performed at a ratio (e.g., m %) that is as close as possible to the predetermined pruning ratio while satisfying the condition described above. Thus, the remaining lines (e.g., (M-m)%) unpruned through the coarse-grained pruning may be pruned in the fine-grained pruning performed subsequently.

At operation 320, the electronic device 1200 may perform FFN dimension pruning. The FFN dimension pruning may be a method of pruning lines in a direction of d_ffn, which is one of the dimensions of an FFN. Depending on a type of weights, the pruning may be performed in a column direction or in a row direction.

At operation 330, the electronic device 1200 may perform a head reorganization operation to reorganize the heads based on the unpruned lines after the coarse-grained pruning. The electronic device 1200 may convert (or “transform” herein) a sparse matrix into a dense matrix. The electronic device 1200 may remove dₛ×(H−Hᵣ) lines from W_{Q}, W_{K}, and W_{V} through the coarse-grained pruning. In this case, the electronic device 1200 may adjust the reduced column sizes of W_{Q}, W_{K}, and W_{V} to match the reduced row sizes of W_{O} to ensure compatibility and consistency of matrix operations. The column size of an output after embedding (d_{model}) of query, key, and value may be reduced after the coarse-grained pruning of W_{Q}, W_{K}, and W_{V} (i.e.,

$${d}_{model}^{′} = {\sum }_{h = 0}^{{H}_{r}} {d}_{z}^{h} where {H}_{r} = ( 1 - m / 100 ) \times H ) .$$

The column size of a concatenated matrix A_{O} may also be reduced. Thus, to perform a matrix multiplication of A_{O} and W_{O}, W_{O} may be pruned at the same pruning ratio as the one applied during the coarse-grained pruning.

At operation 340, the electronic device 1200 may perform the fine-grained pruning on the heads present through the coarse-grained pruning. The fine-grained pruning may be to perform additional line-wise pruning within each attention head. The fine-grained pruning may be pruning lines whose importance scores are below the threshold value among lines unpruned by the coarse-grained pruning. That is, it may be performing line removal to remove lines that have not been removed through the coarse-grained pruning. By pruning the lines unpruned through the coarse-grained pruning, although their importance scores do not satisfy the threshold value, a target pruning ratio (e.g., M %) may be acquired. Similar to the coarse-grained pruning, rows in W_{O} that correspond to columns of W_{Q}, W_{K}, and W_{V} that have been pruned may be pruned.

Although not shown, the electronic device 1200 may perform dynamic PTQ after the fine-grained pruning. The electronic device 1200 may perform intra-layer dynamic linear quantization on the weights of the transformer model to perform the optimization operation 300. In one embodiment, to perform PTQ, the electronic device 1200 may adopt DF8, a dynamic fixed-point (DFP) format that dynamically changes the number of decimal bits of a fixed point, defined by Equations 1 to 5 below.

$${Q}_{8 bit}^{F P} = \pm α \times \{ 0 , \frac{1}{{2}^{8 - 1} - 1} , \frac{2}{{2}^{8 - 1} - 1} , ... , 1 \} \qquad [ Equation 1 ]$$

$$\hat{x} = D {F}_{8} ( x ) = α \cdot ( \frac{1}{{2}^{8} - 1} round ( ( {2}^{8} - 1 ) \cdot \text{⌈x, α⌋} ) \qquad [ Equation 2 ]$$

$$⌈ x , α ⌋ = \{ \begin{matrix}- 1 & x < - α \\ x / α & - α \leq x \leq α \\ 1 & x > α\end{matrix} \qquad [ Equation 3 ]$$

$${α}_{w} = {2}^{B {W}_{min} ( ceil ( max ( {W}_{i}^{layer} ) ) )} \qquad [ Equation 4 ]$$

$${a}_{in} = {2}^{B {W}_{min} ( ceil ( max ( {A}_{8 : {T}_{M} , 0 : {T}_{N}}^{layer} ) ) )} \qquad [ Equation 5 ]$$

In Equation 3, the electronic device 1200 may convert (or transform) a data range into an interval [−1, 1] through ┌w (or x), α┘. In Equations 4 and 5, scaling factors α_{w} and αᵢₙ may be dynamically adjusted based on the data range. In addition, a zero point may always be set to zero (0). BWₘᵢₙ may denote a minimum bit width required for an integer part of data. A small scaling factor (e.g., αᵢₙ, α_{w}) may reduce a range of quantized values, which may cause a higher number of decimal places (n). This may allow a quantized value to more accurately represent a decimal part of an original value. Conversely, a large scaling factor may increase the range of the quantized values, which may cause a lower number of decimal places. In other words, although a total bit width is fixed at 8 bits, the precision of a fixed-point representation, denoted by (8, mix), may be dynamically adjusted by varying the number of fractional bits (n). This may allow the electronic device 1200 to represent a range of values with varying levels of precision.

In one embodiment, the electronic device 1200 may organize multiple data sets and determine a single representative value for each set. The electronic device 1200 may perform PTQ to identify an appropriate decimal precision (n) and integer precision (8−n) for each data set, thereby minimizing a quantization effect on the representative value. The method described above may be implemented in a manner such as Algorithm 1 below.

Algorithm 1 The proposed intra-layer or tile-based dynamic post-training quantization

| | |
|---|---|
| 1: | Input: A transformer model Af in 32-bit floating-point with 1-th layer weight tensor |
| | W^{l} (1 ≤ l ≤ L) |
| 2: | $\text{Output:} The quantized model \hat{M} , where each weight {W}_{Q , K , V , O , F 1 , F 2}^{l} in a$ |
| | $layer has a different fractional scales and each tile of all activations {A}_{0 : {T}_{M} , 0 : {T}_{N}}^{l}$ |
| | has a different fractional scales |
| 3: | # Post-Training Quantization |
| 4: | for layer l = 1 to L do |
| 5: | $in {W}_{Q , K , V , O , F 1 , F 2}^{l} do$ |
| 6: | $Find scaling factor of {W}_{i}^{l}$ |
| 7: | Assign quantization precision m and n. |
| 8: | where m: integer precision, n: fractional precision, m + n = 8 |
| 9: | ${\hat{W}}_{i}^{l} ← D {F}_{8} ( {W}_{i}^{l} )$ |
| 10: | Return: \hat{M} ← M(Ŵ^{l}) |
| 11: | # On-the-fly Post-Training Quantization in the Dedicated Accelerator |
| 12: | for layer l = 1 to L do |
| 13: | for height h to H do |
| 14: | for width w to W do |
| 15: | for tm = 0 to T_{M} do |
| 16: | for tn = 0 to T_{N} do |
| 17: | $Find scaling factor of {A}_{0 : {T}_{M} , 0 : {T}_{N}}^{l}$ |
| 18: | Assign quantization precision m and n |
| 19: | ${\hat{A}}_{0 : {T}_{M} , 0 : {T}_{N}}^{l} ← D {F}_{8} ( {A}_{0 : {T}_{M} , 0 : {T}_{N}}^{l} )$ |

In Algorithm 1, the fractional precision n may have different values for each weight type (e.g.,

$${W}_{Q , K , V , O , ... )}^{layer}$$

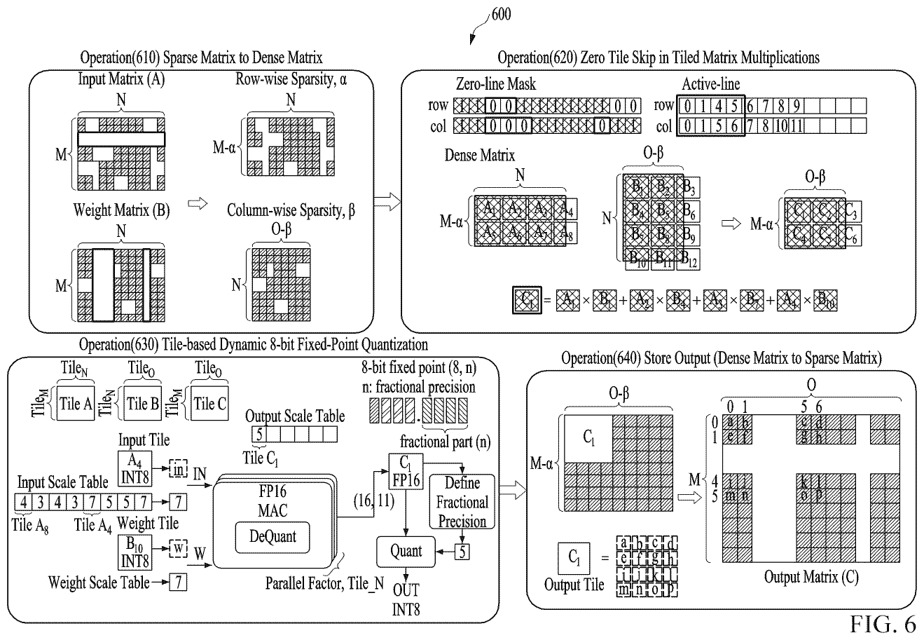

in each layer. PTQ of weight parameters may be performed offline. However, an online PTQ method may need to be used for activation. For each tile (e.g., A_{(O:T}_{_{M,}}_{O:T}_{_{N}}₎), n may have a different value. This may indicate that SQ-GEMM described below with reference to FIGS. 6 through 9 may support online PTQ for input and output activation in a tile-based manner.

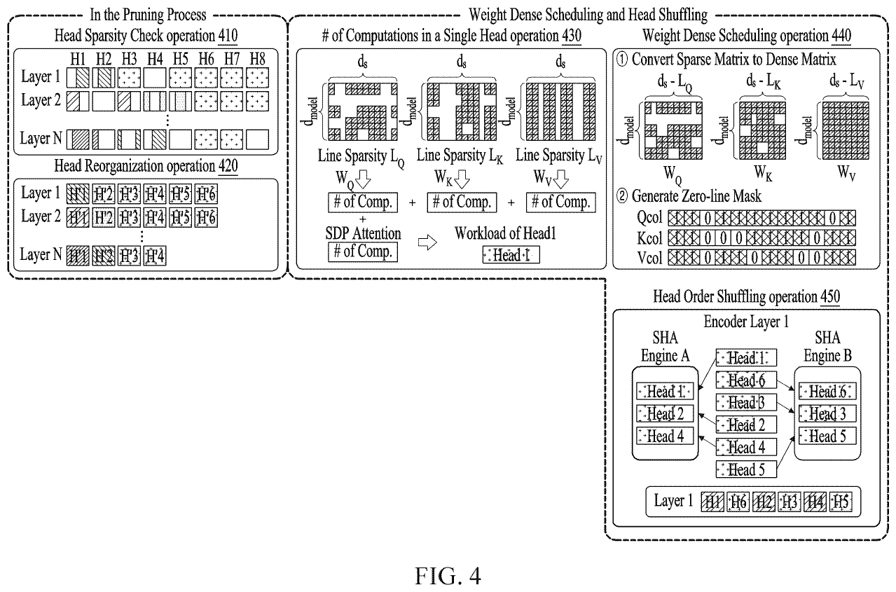

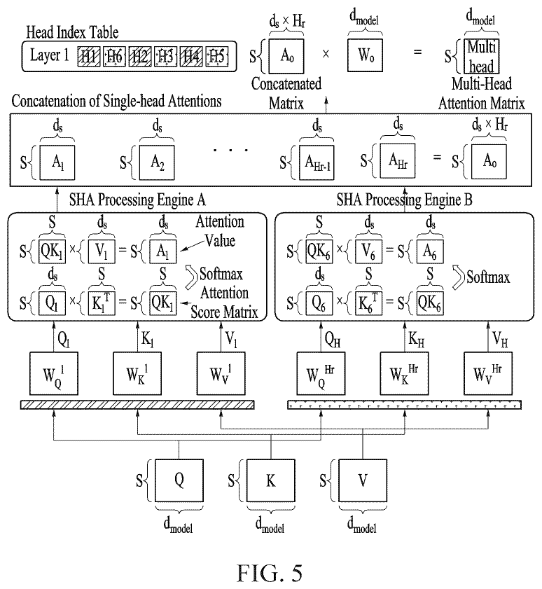

FIGS. 4 and 5 are schematic diagrams illustrating a head scheduling operation of an electronic device according to an embodiment.

The description provided above with reference to FIGS. 1 through 3 may be equally applicable to FIGS. 4 and 5, and may thus not be repeated.

One or more blocks and combinations of blocks shown in FIGS. 4 and 5 may be implemented by a special-purpose hardware-based computer that performs a specific function, or by a combination of special-purpose hardware and computer instructions.

For ease of description, operations 410 through 450 are described as being performed using the electronic device 1200 shown in FIG. 12. However, operations 410 through 450 may be used with any other suitable electronic device and within any suitable system.

Further, although the operations described with reference to FIG. 4 may be performed in the order and manner as shown, the order of some of the operations may be changed or some of the operations may be omitted without departing from the spirit and scope of the embodiments shown and described. The operations described with reference to FIG. 4 may be performed in parallel or simultaneously.

In one embodiment, the electronic device 1200 may perform a head scheduling operation that optimizes the placement of heads based on a workload of the heads on which pruning has been performed.

In one embodiment, the electronic device 1200 may arrange multiple SHA PEs and reuse an engine to concatenate SHA results to complete an MHA task.

Heads remaining from additional row and block pruning after head-wise pruning may have different workloads. When the multiple PEs operate in parallel, an unbalanced workload problem may occur in SHA. Therefore, the electronic device 1200 may operate according to a data flow that operates the SHA by mixing the order of heads and grouping the heads having a similar number of operations.

Referring to FIG. 4, the electronic device 1200 may perform i) operations 410 and 420 that skip an unnecessary head operation, and ii) operations 430, 440, and 450 (e.g., weight dense scheduling and head shuffling) that address the workload imbalance problem when two SHA processing engines are operating in parallel.

At operation 410 (e.g., head sparsity check), the electronic device 1200 may identify pruned heads in all layers and remove zero weights included in a single head to skip the unnecessary head operation. For example, the operations of identifying H1, H2, and H4 that is a zero-weight single head in Layer 1, and identifying H1, H3, H4, H5, and H2 that is a zero-weight single head in Layer 2, may be performed for all layers, and zero weights may be removed.

At operation 420 (e.g., head reorganization), the electronic device 1200 may perform dense weight scheduling by pushing the remaining weights stored behind the pruned heads. For example, for Layer 1, the dense weight scheduling may be performed through line pruning performed on H1 and H2 and head pruning performed on H4, leaving weights only in H′1 through H′6. Similarly, for Layer 2, line pruning may be performed on H1, H3, H4, and H5 and head pruning may be performed on H2, leaving weights only in H′i through H′6. The electronic device 1200 may repeat this process for each of the layers.

At operation 430 (e.g., #of computation in a single head), the electronic device 1200 may determine (or check) row-wise sparsity and column-wise sparsity of each of heads included in encoder layers of a transformer model. The electronic device 1200 may then use the row-wise sparsity and block-wise sparsity to acquire the required number of operations per head in one layer. When calculating a computational load (or an operation load), the electronic device 1200 may calculate it by referring to the sparse matrix of FIG. 2. However, in this embodiment, the operation of determining (or checking) the block-wise sparsity may be optionally performed depending on an execution environment of the electronic device 1200.

At operation 440 (e.g., weight dense scheduling), the electronic device 1200 may convert (or “transform” herein) a sparse matrix into a dense matrix by removing zero lines from each of the heads. The electronic device 1200 may transform the sparse matrix into the dense matrix by removing all zero rows that do not require an operation to save a memory storage space. Additionally, the electronic device 1200 may generate a zero-line mask indicating whether each row needs to be skipped. However, in this embodiment, the operation of removing the block-wise sparsity to generate the dense matrix may be optionally executed depending on the execution environment of the electronic device 1200.

At operation 450 (e.g., head order shuffling), the electronic device 1200 may perform an operation of optimizing the placement of the heads in a corresponding layer based on the workload of each of the heads. The electronic device 1200 may shuffle the order of head operations and group two heads within an encoder layer that have a similar number of operations, and may distribute them to the SHA to perform the operations. For example, the electronic device 1200 may sort pairs of the two in descending order by the number of operations of the heads, and distribute the paired heads between two SHA PEs (e.g., between SHA engine A and SHA engine B).

For example, in Encoder Layer 1, the electronic device 1200 may assign Head 1 and Head 6 as a first group because they have a similar number of operations, Head 3 and Head 2 as a second group because they have a similar number of operations, and Head 4 and Head 5 as a third group because they have a similar number of operations. The electronic device 1200 may then sort the first group, the second group, and the third group in descending order to arrange the heads in order of Heads 1, 6, 3, 2, 4, and 5. In this case, assuming that the SHA engine A and the SHA engine B are present in Encoder Layer 1, Heads 1, 2, and 4 may be assigned to the SHA engine A, and Heads 6, 3, and 5 may be assigned to the SHA engine B such that the total workloads of operations for the respective SHA PEs remain similar. The electronic device 1200 may repeat this operation for all layers.

FIG. 5 illustrates a new data flow of MHA using two SHA PEs and a head direction skipping operation. The electronic device 1200 may generate a head scheduling table (e.g., Layer 1=[H1, H6, H2, H3, H4, H5]) through the head shuffling operation described above. As the head reorganization operation reduces the number of heads, the operation (or computation) of the SHA may be omitted, reducing the computational overhead of the MHA. The electronic device 1200 may sequentially execute the two SHAs based on the shuffled head operations and store them in an appropriate memory location. In a first encoder layer, SHA B may manage the sixth, third, and fifth heads, and SHA A may manage the first, second, and fourth heads.

FIG. 6 is a schematic diagram illustrating an operation of a transformer accelerator according to an embodiment.

The description provided above with reference to FIGS. 1 through 5 may be equally applicable to FIG. 6, and may thus not be repeated.

For ease of description, operations 610 through 640 are described as being performed using the electronic device 1200 shown in FIG. 12. However, operations 610 through 640 may be used with any other suitable electronic device and within any suitable system.

Further, although the operations described with reference to FIG. 6 may be performed in the order and manner as shown, the order of some of the operations may be changed or some of the operations may be omitted without departing from the spirit and scope of the embodiments shown and described. The operations described with reference to FIG. 6 may be performed in parallel or simultaneously.

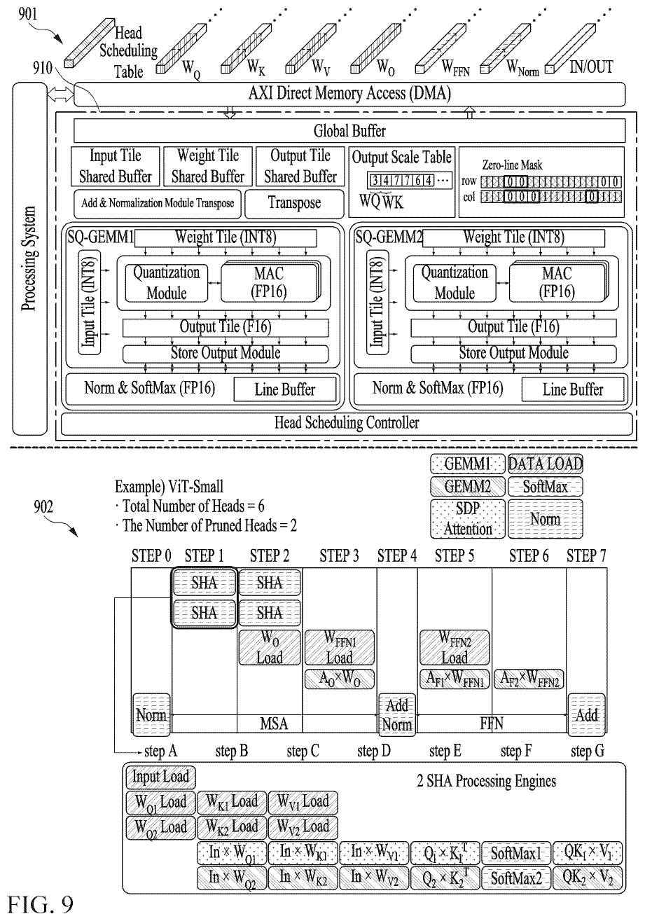

In one embodiment, the electronic device 1200 may include a transformer accelerator (e.g., a transformer accelerator 910 of FIG. 9) configured to perform an SQ-GEMM operation 600. The SQ-GEMM operation 600 may be implemented through a separate hardware device, and the transformer accelerator may include a separate hardware device.

The SQ-GEMM operation 600 may be an operation that performs an SQ-GEMM. In the SQ-GEMM operation 600, a row-wise or column-wise sparse matrix may be transformed into a matrix that has a dense form in advance to support line-based skipping. In the SQ-GEMM operation 600, the transformer accelerator may store which lines are not empty based on index bits such as row and column sizes. The SQ-GEMM operation 600 may be an operation that performs a tiling-based matrix multiplication. The SQ-GEMM operation 600 may be an operation that skips a matrix multiplication including zero tiles to support block-based skipping.

At operation 610 (e.g., sparse matrix to dense matrix), the transformer accelerator may receive data associated with operations of a transformer model and transform the data into dense data. The transformer accelerator may transform each of received input data and weight data into dense data.

In this case, at least one of the input data or the weight data may be data for which the transformer model optimization and head scheduling operation described above has not been performed. Thus, the transformer accelerator may change, into the dense data, the data on which the transformer model optimization and head scheduling operation has not been performed.

The transformer accelerator may perform the SQ-GEMM. When multiplying a matrix A [M×N] and a matrix B [N×O] and outputting a matrix C [M×O], the transformer accelerator may determine (or check) row-wise sparsity of the matrix A and column-wise sparsity of the matrix B. For example, when every element in an ith row of the input matrix A is zero (0), then every element in an ith row of the output matrix C may also be zero (0). In addition, when a jth column of the input matrix B is a zero row, then a jth column of the output matrix C may also be a zero row. When the data is transferred to the transformer accelerator, the input data and the weight data may be transferred.

In the case of dense scheduling data described below, it may refer to data on which the transformer model optimization and head scheduling operation has been performed, and may refer to transformer model weight data on which the optimization and head scheduling operation has been performed.

At operation 620 (e.g., zero tile skip in tiled matrix multiplications), the transformer accelerator may receive dense scheduling data and a zero-line mask generated by the transformer model optimization and head scheduling operation. The transformer accelerator may output a dense operation result by performing a tiled matrix multiplication based on at least one of the dense data, the dense scheduling data, or the zero-line mask. That is, the transformer accelerator may use the dense data, the dense scheduling data, and the zero-line mask as an input to the SQ-GEMM operation 600. The transformer accelerator may perform the matrix multiplication using dense matrices A′ [(M−α)×N] and B′ [N×(O−β)] that are acquired based on tiling. In exceptional cases where the size of an input matrix is not a multiple of the tiling size, it may fill a remaining part with zero values (0) and perform lastly the tiled matrix multiplication, and may not store it in a resulting matrix (e.g., A4 and A8). To apply block-wise skipping, the transformer accelerator may check in real time if a tiled matrix has zero tiles and may skip a multiplication of a tiled matrix including the zero tiles.

At operation 630, the transformer accelerator may perform tile-based DFP quantization on the dense data or the dense scheduling data. In particular, for the input data, since a data value may vary in real time, the transformer model optimization and head scheduling operation described above may not be performed in advance. Therefore, the transformer accelerator may need to perform the tile-based DFP quantization on the input data. The transformer accelerator may transform input data and weight data included in the dense scheduling data into an INT8 data type. The transformer accelerator may perform dequantization that divides a result of a multiplication operation of the transformed input data and the transformed weight data by a fractional precision. The transformer accelerator may perform quantization on a first operation result acquired through the dequantization and transform it into a second operation result of the INT8 type, and store the fractional precision separately.

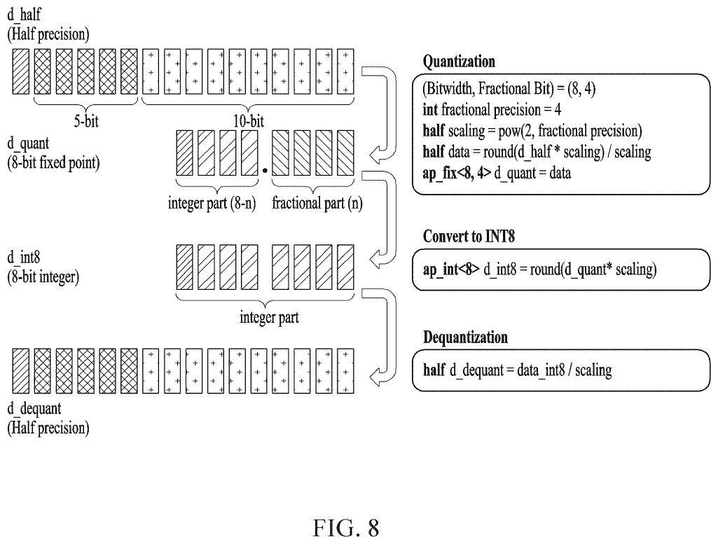

In the tiled matrix multiplication, the transformer accelerator may quantize multiply-accumulate (MAC)-unit data using a fractional precision (fᵢₙ, f_{w}) of the input data and the weight data, and quantize an output tile when the tile-wise operation is completed. When an output tile buffer is full, a fractional precision (fₒᵤₜ) of the output tile may be determined based on an absolute maximum value in the buffer, and be quantized and transformed into INT8 as shown in FIG. 8. An input scale table may store various fractional precisions of an input tile, and a weight scale table may store one fractional precision of a weight tile. The fractional precision of a weight may vary depending on a type of weight within a layer. Since data within each tile has the same fractional precision, performing quantization with the fractional precision may be performed by grouping the data into tiles.

At operation 640, the transformer accelerator may output a final operation result by transforming the dense operation result into a sparse matrix, using the zero-line mask. As the dense matrix is transformed into the sparse matrix, the operation may be completed, and zero data excluded from the operation may be returned to its appropriate location. However, the post-processing described above may require a buffer of the same size as the dense output matrix C′ [(M−α)×(O−β)]. Instead, the transformer accelerator may calculate in advance an output index, and immediately store an output in an appropriate location to remove buffer overhead required for the dense matrix. In particular, in pruning, patch pruning for an input image may increase row-wise sparsity, and column pruning for weights may increase column-wise sparsity. However, using the transformer accelerator may prevent the latency from increasing as the sparsity increases.

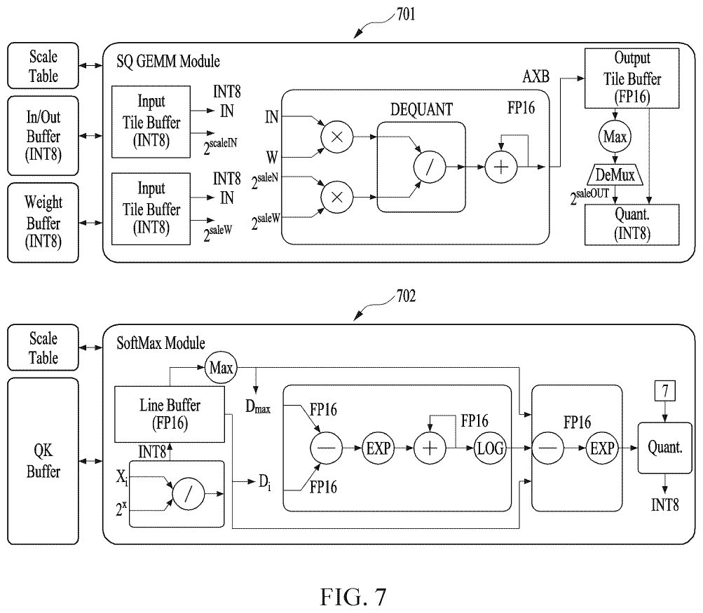

FIG. 7 is a schematic diagram illustrating an SHA PE operating an SQ-GEMM according to an embodiment.

The description provided above with reference to FIGS. 1 through 6 may be equally applicable to FIG. 7, and may thus not be repeated.

The transformer accelerator 910 included in the electronic device 1200 described above may include one or more SHA PEs.

In one embodiment, an SHA PE may include an SQ-GEMM module 701, a softmax module 702, and multiple buffers. The SQ-GEMM module 701 may perform the SQ-GEMM operation 600 to output a result (A×B) of a matrix multiplication of sparse quantized matrices A and B. Equation 6 below, which is a translation of a softmax equation, may implement the softmax module 702 to reduce the computational overhead of the SHA PE.

$$SoftMax ( {x}_{i} ) = exp ( {x}_{i} - {x}_{max} - ln ( {\sum }_{j = 1}^{N} exp ( {x}_{j} - {x}_{max} ) ) ) \qquad [ Equation 6 ]$$

As used in connection with certain embodiments of the disclosure, the term “module” may include a unit implemented in hardware, software, or firmware, or any combination thereof, and may interchangeably be used with other terms, for example, “logic,” “logic block,” “component,” “part,” or “circuit.” A module may be a single integral component, or a minimum unit or part thereof, adapted to perform one or more functions. The module may be implemented mechanically or electronically. For example, the module may be implemented in the form of at least one of an application-specific integrated circuit (ASIC) chip, a field-programmable gate array (FPGA), or a programmable-logic device that performs certain known operations or certain operations in development.

FIG. 8 is a diagram illustrating tile-based DFP quantization in an SQ-GEMM operation (e.g., the SQ-GEMM operation 600) according to an embodiment.

The description provided above with reference to FIGS. 1 through 7 may be equally applicable to FIG. 8, and may thus not be repeated.

In one embodiment, tile-based DFP quantization may be an operation performed at operation 630 described above with reference to FIG. 6.

Referring to FIG. 8, a transformer accelerator (e.g., the transformer accelerator 910 of FIG. 9) may perform tile-based DFP quantization. FIG. 8 illustrates an example where quantization from half precision to 8-bit fixed-point (8, 4), conversion (also “transformation” herein) into INT8, and dequantization from INT8 to half precision are performed.

In one embodiment, the transformer accelerator 910 may perform the tile-based DFP quantization through i) conversion into INT8, ii) dequantization, and iii) quantization functions. Algorithm 2 below outlines a high-level synthesis (HLS) for the transformer accelerator 910.

Algorithm 2 SQ-GEMM

| | |
|---|---|
| 1: | Array in₀bu f f[Tile_{M}][Tile_{N}] |
| 2: | Array w₀bu f f[Tile_{N}][Tile_{O}] |
| 3: | Array out₀bu f f[Tile_{M}][Tile_{O}] |
| 4: | #pragma HLS array partition variable input type=cyclic |
| | factor=Tile_{N} dim=2 |
| 5: | #pragma HLS array partition variable weight type=cyclic |
| | factor=Tile_{N} dim=1 |
| 6: | #pragma HLS EXPRESSION_BALANCE off |
| 7: | Generate active line index, denseM (M-α) and denseO (O-β) |
| 8: | for m = 0 to denseM do |
| 9: | for o = 0 to denseO do |
| 10: | Initialize out₀bu f f |
| 11: | for n = 0 to N do |
| 12: | Load Data(input, in₀bu f f) |
| 13: | Load Data(weight, w₀bu f f) |
| 14: | f_{scale} = f_{scale}_{ᵢₙ} * f_{scale}_{_{w}} |
| 15: | (where f_{scale}_{ᵢₙ} = 2^{fin} and f_{scale}_{_{w}} = 2^{fw}⁾ |
| 16: | if in₀bu f f and w₀bu f f are not zero tiles then |
| 17: | for i = 0 to Tile_{M} do |
| 18: | for j = 0 to Tile_{O} do |
| 19: | # pragma HLS pipeline |
| 20: | for k = 0 to Tile_{N} do |
| 21: | INT8 dataᵢₙ = in₀bu f f |
| 22: | INT8 data_{w} = w₀bu f f |
| 23: | hal f accum = (dataᵢₙ *data_{w}) / f_{scale} |
| 24: | out₀bu f f ← out₀bu f f + accum |
| 25: | n ← n + Tile_{N} |
| 26: | Select f_{scale}_{ₒᵤₜ} referring to the absolute |
| | maximum value of (out₀bu f f) |
| 27: | out₀bu f f quantization with f_{scale}_{ₒᵤₜ} |
| 28: | Get active_line_index, row[Tile_{M}] and col[Tile_{O}] |
| 29: | Store Output(out₀bu f f, output, active_line_index, f_{scale}_{ₒᵤₜ}) |
| 30: | o ← o + Tile_{O} |
| 31: | m ← m + Tile_{M} |

Algorithm 2 may be HLS code for a tile matrix multiplication in the transformer accelerator 910. In the transformer accelerator 910, the HLS array partition pragma may be applied to input and weight arrays. A cyclic array partition may reorganize elements in an original array to generate a smaller array. For example, the transformer accelerator 910 may set an array partition factor of the input array to Tile_{N} and set the dimension to 2 to cyclically partition the Tile_{N} array in a two-dimensional direction such that the Tile_{N} data may be accessed simultaneously (refer to lines 4-5 of Algorithm 2). The transformer accelerator 910 may perform the two-dimensional (dim2) and one-dimensional (dim1) array partitioning of the input and weight tile buffers, by the times equal to the tile size, Tile_{N}, to allow multiple data to be read and calculated all at once.

In one embodiment, the transformer accelerator 910 may transform input data and weight data included in dense data or dense scheduling data into an INT8 data type. A default data type of the input and weight buffers may be INT8 because it supports a wide range of fractional precisions. Therefore, preprocessing may be required to shift 8-bit fixed-point data by a bit width of a fractional part and round a value to transform it into the INT8 data type.

In one embodiment, the transformer accelerator 910 may perform dequantization. The transformer accelerator 910 may perform dequantization that divides a result of a multiplication operation of the transformed INT8 input data and the transformed weight data by the fractional precision.

Dynamic quantization may perform tile-wise quantization to ensure that all data within input tiles or weight tiles share the same fractional precision. Rather than dequantizing the input and weight data respectively to restore them to their original values, the transformer accelerator 910 may use a more efficient approach. A combined fractional precision (e.g., 2^{fin+fw}) may be consistent across all the tiles, and this value may be stored in a single register. The combined fractional precision may be reused during the dequantization process. In this case, optimization that reuses the combined fractional precision may simplify the dequantization process by, for example, reading the fractional precision value only once during a single tile matrix multiplication and halving the number of division operations. In other words, the transformer accelerator 910 may multiply the input (e.g., INT8) and the weight (e.g., INT8), read the combined fractional precision stored in the single register, and then divide the multiplied value once (refer to line 23 of Algorithm 2).

In one embodiment, the transformer accelerator 910 may perform quantization. The transformer accelerator 910 may perform quantization on an operation result acquired by the dequantization described above, and transform it into an operation result of INT8 type and separately store the fractional precision described above.

When one output tile is completed, the transformer accelerator 910 may determine a scaling factor α and a fractional precision fₒᵤₜ representing the output tile, using an integer bit-width of an absolute maximum value of the one output tile (refer to line 26 of Algorithm 2). When the transformer accelerator 910 quantizes data into dynamic fixed-point 8-bit (DF8), the fractional precision may have a bit width of 0 to 7 bits. Using the absolute maximum value to determine the fractional precision may minimize the loss of an accumulated result, and preserving a large integer part may be important to preserve accuracy. A large value may indicate a greater importance, primarily in an attention mechanism. Before storing output data in a global buffer, the transformer accelerator 910 may shift the data type by the fractional precision to convert the data type back into INT8 from DF8. The transformer accelerator 910 may store the fractional precision in a separate scale table. An output scale table may be an input scale table for a subsequent matrix multiplication.

FIG. 9 is a diagram illustrating a transformer accelerator including an SQ-GEMM module according to an embodiment.

The description provided above with reference to FIGS. 1 through 8 may be equally applicable to FIG. 9, and may thus not be repeated.

One or more blocks and combinations of blocks shown in FIG. 9 may be implemented by a special-purpose hardware-based computer that performs a specific function, or by a combination of special-purpose hardware and computer instructions.

Referring to FIG. 9, an electronic device 901 (e.g., the electronic device 1200 of FIG. 12) may include a processing system, an advanced extensible interface (AXI) direct memory access (DMA) (AXI DMA), and the transformer accelerator 910. The AXI DMA may be used to transmit and receive data between the processing system and the transformer accelerator 910. The transformer accelerator 910 may include a global buffer, at least one SQ-GEMM module (e.g., SQ-GEMM 1 and SQ-GEMM 2), a head scheduling controller, an add and normalization module, a transpose module, and the like. The electronic device 901 may optimize a transformer model and schedule (or shuffle) heads through the transformer model optimization and head scheduling operation described above. The electronic device 901 may also perform, using the processing system, the transformer model optimization and head scheduling operation. In this case, the transformer model optimization and head scheduling operation may be performed by the electronic device 901, but may also be performed by another computing system or another electronic device and input to the electronic device 901.

The head scheduling controller may acquire a shuffling order of the heads such that, when the transformer accelerator 910 completes performing the operations and stores corresponding results, the results may be stored in a correct order. The shuffling order of the heads may be predetermined when there is an input to the transformer accelerator 910 via the AXI DMA from the processing system of the electronic device 901. The transpose module, a zero-line mask module, and the like may be hardware that performs related functions. For example, the zero-line mask module may refer to storing data such as 0101 in a schedule buffer. Also, various buffers shown in the drawings may be hardware such as an on-chip memory (e.g., a register and a buffer) that stores input data, output data, and intermediate data generated in between.

In a data flow 902, the transformer accelerator 910 may output a result (A×B) of a matrix multiplication of matrix A and matrix B through the SQ-GEMM operation 600. On the other hand, an SDP attention module may output an SDP attention result (A×B^{T}/C). In particular, the SDP attention module may reduce the overhead of a matrix transposition by directly performing the multiplication of the matrix A and a matrix B^{T} without transposing the matrix B.

A part of loading, into a tile buffer, data from the SQ-GEMM module (e.g., the SQ-GEMM module 701) and the SDP attention module, a computation (or calculation) part, and a part of storing a final output tile in a memory may be pipelined.

A data flow 902 may be an example of a data flow in an encoder layer of ViT-Base. At all steps, while the SQ-GEMM module is processing data in one buffer, an input channel may store data in another buffer to follow a process of the SQ-GEMM module. All the input data and weight data may be loaded through the AXI DMA, without passing through the processing system.

At step 1 and step 2, a concatenated matrix may be generated by performing the number of SHA operations equal to the total number of heads remaining in MSA (i.e., Hr=H—the number of pruned heads).

In a case where there is no single head index in a head scheduling index, the operations of corresponding SHA may be skipped, and zeros (0) may fill instead of an attention value that is an output of the SHA. Based on an order in which the heads are shuffled for each layer, two SHA PEs may be used in an appropriate order to perform operations, and two acquired attention values may be stored in appropriate locations.

An SHA PE may generate embedding vectors of query (Qi), key (Ki), and value (Vi) by performing a matrix multiplication of respective weights (W_{Q}, W_{K}, W_{V}) and an input query Q, an input key K, and an input value V (e.g., at steps A-D). At steps E-G, the SDP attention module may generate an attention score matrix Qkᵢ by performing SDP attention (e.g.,

$$( Attention ( {Q}_{h} , {K}_{h} , {V}_{h} ) = Softmax ( {Q}_{h} {K}_{h}^{T} / \sqrt{{d}_{k}} ) {V}_{h} ) .$$

The SQ-GEMM module may perform a matrix multiplication of an attention distribution and a value vector Vᵢ, which are output after softmax, to output an attention value Aᵢ. Therefore, since the transformer accelerator 910 of FIG. 9 has two SHA PEs, two attention values may be generated in parallel. The transformer accelerator 910 may repeat steps A-F four times (Hᵣ/number of SHA PEs).

At step 3, the SQ-GEMM module may perform a matrix multiplication between a concatenated matrix A_{O} and a weight matrix W_{O} to complete a multi-head attention matrix. At steps 4-7, an FFN may use two additional SQ-GEMM modules. In between the operations of the MSA and the FFN, the add and normalization module may add a previous input to an output and normalize it.

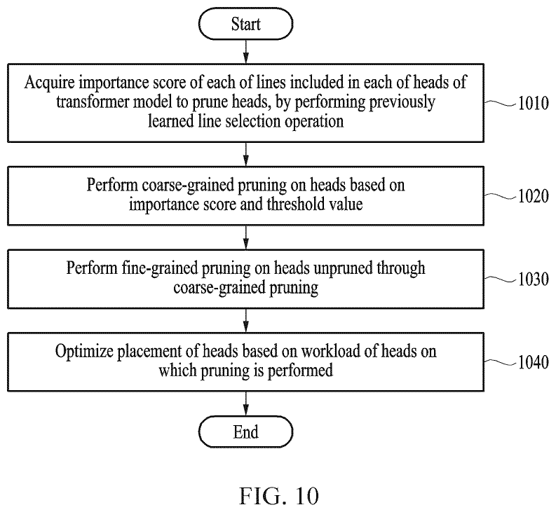

FIG. 10 is a flowchart illustrating a flow of operations of an electronic device according to an embodiment.

The description provided above with reference to FIGS. 1 through 9 may be equally applicable to FIG. 10, and may thus not be repeated.

At operation 1010, an electronic device (e.g., 901 and 1200) may acquire an importance score for each of lines included in each of heads of a transformer model to prune the heads of the transformer model by performing a previously learned line selection operation.

At operation 1020, the electronic device (e.g., 901 and 1200) may perform coarse-grained pruning on the heads based on the importance score and a threshold value. The threshold value may be determined based on the importance score and a ratio of lines to be removed among lines of a predetermined pruning ratio. The coarse-grained pruning may be to prune lines whose importance scores are below the threshold value, based on a predetermined condition.

The electronic device (e.g., 901 and 1200) may reorganize the heads based on unpruned lines after the coarse-grained pruning.

At operation 1030, the electronic device (e.g., 901 and 1200) may perform fine-grained pruning on the heads unpruned through the coarse-grained pruning. The fine-grained pruning may be to prune lines whose importance scores are below the threshold value among the lines unpruned through the coarse-grained pruning.

The electronic device (e.g., 901 and 1200) may perform dynamic PTQ on heads pruned through the fine-grained pruning. The electronic device (e.g., 901 and 1200) may perform intra-layer dynamic linear quantization.

At operation 1040, the electronic device (e.g., 901 and 1200) may optimize the placement of the heads based on the workload of the heads on which the pruning has been performed. The electronic device (e.g., 901 and 1200) may determine (or check) row-wise sparsity and column-wise sparsity for each of heads included in each of encoder layers of the transformer model. The electronic device (e.g., 901 and 1200) may transform a sparse matrix into a dense matrix by removing zero lines from each of the heads. Based on the workload of each of the heads, the electronic device (e.g., 901 and 1200) may optimize the placement of the heads in each layer.

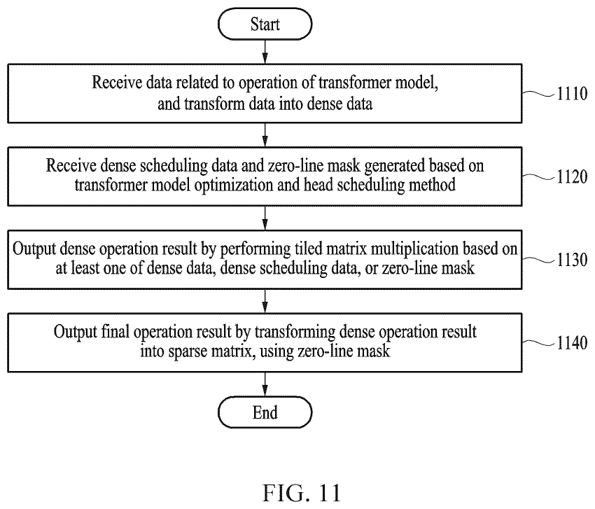

FIG. 11 is a flowchart illustrating a flow of operations of a transformer accelerator according to an embodiment.

The description provided above with reference to FIGS. 1 through 10 may be equally applicable to FIG. 11, and may thus not be repeated.

At operation 1110, the transformer accelerator 910 may receive data associated with operations of a transformer model and transform the data into dense data.

At operation 1120, the transformer accelerator 910 may receive dense scheduling data and a zero-line mask generated based on a transformer model optimization and head scheduling method.

At operation 1130, the transformer accelerator 910 may output a dense operation result by performing a tiled matrix multiplication based on at least one of the dense data, the dense scheduling data, or the zero-line mask. The transformer accelerator 910 may perform tile-based DFP quantization on the dense data or the dense scheduling data. The transformer accelerator 910 may transform input data and weight data included in the dense data or the dense scheduling data into an INT8 type. The transformer accelerator 910 may perform dequantization that divides a result of a multiplication operation of the transformed input data and the transformed weight data by a fractional precision. The transformer accelerator 910 may obtain an operation result of an INT8 type by performing quantization on the dequantization result, and may store the fractional precision separately.

At operation 1140, the transformer accelerator 910 may output a final operation result by transforming the dense operation result into a sparse matrix, using the zero-line mask.

FIG. 12 is a block diagram illustrating an electronic device according to an embodiment.

The description provided above with reference to FIGS. 1 through 11 may be equally applicable to FIG. 12, and may thus not be repeated.

Referring to FIG. 12, the electronic device 1200 according to one embodiment may include a processor 1230, a memory 1250, and an output device 1270 (e.g., a display). The processor 1230, the memory 1250, and the output device 1270 may be connected to each other via a communication bus 1205.

In one embodiment, the electronic device 1200 may be the electronic device 901 of FIG. 9. The electronic device 1200 may perform the transformer optimization and head scheduling operation described above, or may be the electronic device 901 including the transformer accelerator 910 described above.

The output device 1270 may display a user interface (UI) for specifying operations to be performed by the processor 1230 or for transmitting and receiving user inputs, and may display results of the performed operations.

The memory 1250 may store information associated with a transformer model, a transformer model optimization and head scheduling method, and an SQ-GEMM that are performed in the processor 1230. The memory 1250 may also store various other information generated during a processing process of the processor 1230 described above. The memory 1250 may also store various data, programs, and the like. The memory 1250 may include a volatile memory or a non-volatile memory. The memory 1250 may include a mass storage medium, such as a hard disk, to store various data.

Further, the processor 1230 may perform at least one of the methods described above with reference to FIGS. 1 through 11 or an algorithm corresponding to the at least one method. The processor 1230 may be a hardware-implemented data processing device with a physically structured circuit to execute desired operations. The desired operations may include, for example, code or instructions included in a program. The processor 1230 may be configured as, for example, a central processing unit (CPU), a graphics processing unit (GPU), or a neural network processing unit (NPU). The electronic device 1200, which is hardware-implemented, may include, for example, a microprocessor, a CPU, a processor core, a multi-core processor, a multiprocessor, an application-specific integrated circuit (ASIC), or a field-programmable gate array (FPGA).

The processor 1230 may execute the program and control the electronic device 1200. The code of the program executed by the processor 1230 may be stored in the memory 1250.

The embodiments described herein may be implemented using hardware components, software components and/or combinations thereof. A processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as, parallel processors.

The software may include a computer program, a piece of code, an instruction, or some combination thereof, to independently or collectively instruct or configure the processing device to operate as desired. The software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A transformer model optimization and head scheduling method, comprising:
acquiring an importance score for each of lines comprised in each of heads of a transformer model to prune the heads of the transformer model, by performing a previously learned line selection operation;
performing coarse-grained pruning on the heads, based on the importance score and a threshold value;
performing fine-grained pruning on heads unpruned through the coarse-grained pruning; and
optimizing a placement of the heads based on a workload of the heads on which the coarse-grained pruning and the fine-grained pruning has been performed.

2. The transformer model optimization and head scheduling method of claim 1, wherein the threshold value is determined based on the importance score and a ratio of lines to be removed among lines of a predetermined pruning ratio.

3. The transformer model optimization and head scheduling method of claim 1, wherein the coarse-grained pruning is to prune lines with the importance score less than the threshold value, based on a predetermined condition.

4. The transformer model optimization and head scheduling method of claim 1, wherein the fine-grained pruning is to prune lines with the importance score less than the threshold value among lines unpruned through the coarse-grained pruning.

5. The transformer model optimization and head scheduling method of claim 1, further comprising:
reorganizing the heads based on unpruned lines after the coarse-grained pruning.

6. The transformer model optimization and head scheduling method of claim 1, further comprising:
performing dynamic post-training quantization (PTQ) on heads pruned through the fine-grained pruning.

7. The transformer model optimization and head scheduling method of claim 6, wherein the performing of the dynamic PTQ comprises:
performing intra-layer dynamic linear quantization on a weight of the transformer model.

8. The transformer model optimization and head scheduling method of claim 1, wherein the optimizing of the placement of the heads comprises:
determining a row-wise sparsity and a column-wise sparsity at each of heads comprised in each of encoder layers of the transformer model;
transforming a sparse matrix into a dense matrix by removing zero lines from each of the heads; and
optimizing a placement of the heads in each of the layers, based on a workload of each of the heads.

9. An operating method of a transformer accelerator, comprising:
receiving data associated with operations of a transformer model, and transforming the received data into dense data;
receiving dense scheduling data and a zero-line mask generated based on a transformer model optimization and head scheduling method;
outputting a dense operation result by performing a tiled matrix multiplication based on at least one of the dense data, the dense scheduling data, or the zero-line mask; and
outputting a final operation result by transforming the dense operation result into a sparse matrix, using the zero-line mask.

10. The operating method of claim 9, wherein the outputting of the dense operation result comprises:
performing a tile-based dynamic fixed-point (DFP) quantization on the dense data or the dense scheduling data.

11. The operating method of claim 10, wherein the performing of the tile-based DFP quantization comprises:
transforming, into an INT8 data type, input data and weight data comprised in the dense data or the dense scheduling data.

12. The operating method of claim 11, wherein the performing of the tile-based DFP quantization further comprises:
performing dequantization that divides, by a fractional precision, a result of a multiplication operation between the transformed input data and the transformed weight data.

13. The operating method of claim 12, wherein the performing of the tile-based DFP quantization further comprises:
obtaining an operation result of an INT8 type by performing quantization on the dequantization result; and
storing the fractional precision separately.

14. A non-transitory computer-readable storage medium storing instructions that, when executed by a processor, cause the processor to perform the method of claim 1.

15. An electronic device, comprising:
a memory storing instructions;
a transformer accelerator; and
at least one processor,
wherein the instructions, when executed by the at least one processor, cause the electronic device to:
perform an optimization and head scheduling operation on a transformer model; and
perform an acceleration operation to accelerate, by the transformer accelerator, an operation of the transformer model on which head scheduling has been performed,
wherein the optimization and head scheduling operation comprises:
acquiring an importance score for each of lines comprised in each of heads of the transformer model to prune the heads of the transformer model, by performing a previously learned line selection operation;
performing coarse-grained pruning on the heads based on the importance score and a threshold value;
performing fine-grained pruning on heads unpruned through the coarse-grained pruning; and
optimizing a placement of the heads based on a workload of the heads on which the coarse-grained pruning and the fine-grained pruning has been performed,
wherein the acceleration operation comprises:
receiving data associated with operations of the transformer model, and transforming the data into dense data;
receiving dense scheduling data and a zero-line mask generated based on the optimization and head scheduling operation;
outputting a dense operation result by performing a tiled matrix multiplication based on at least one of the dense data, the dense scheduling data, or the zero-line mask; and
outputting a final operation result by transforming the dense operation result into a sparse matrix, using the zero-line mask.
